(19) United States
(12) Patent Application Publication
(10) Pub. No.: US 2013/0038196 A1
(43) Pub. Date: Feb. 14, 2013

(54) ELECTRODE FOR A DBD PLASMA PROCESS

(71) Applicants: Eric Tixhon, Crisnee (BE); Eric Michel, Liege (BE); Joseph Leclercq, Philippeville (BE)

(72) Inventors: Eric Tixhon, Crisnee (BE); Eric Michel, Liege (BE); Joseph Leclercq, Philippeville (BE)

(73) Assignee: AGC GLASS EUROPE, Bruxelles (Watermael-Boitsfort) (BE)

(21) Appl. No.: 13/643,327

(22) PCT Filed: Apr. 27, 2011
(86) PCT No.: PCT/EP2011/056621

§ 371 Date: Oct. 25, 2012

(30) Foreign Application Priority Data
Apr. 30, 2010 (EP) 10161557.3

(51) Int. Cl. H01J 1/02

(52) U.S. Cl. 313/35; 313/352

(57) ABSTRACT

A planar electrode for the DBD plasma treatment of a surface comprises a metal casing (8) raised to a high voltage and provided with an active part (2) intended to be placed in parallel with a surface to be treated (27). This active part (2) is covered on the outside by a sheet (4) of dielectric material to which it is fixed by a polymer layer (6). The internal face of the active part (2) forms with the metal casing (8) a heat exchanger connected to a secondary cooling circuit (34) through which a refrigerant (10) circulates.

The invention relates to a device (or tool) comprising electrodes intended to be used in the context of treating and/or processing surfaces using a process employing a dielectric barrier discharge (DBD), and particularly to processes for coating volumes of glass, especially continuous production processes.

The invention also relates to a method for manufacturing such an electrode for this device and to such an electrode.

It is well known, especially in the glazing field, but also in the field of plastic films, to treat surfaces with plasma. Such treatment consists in generating a plasma between at least two electrodes and injecting precursors into this plasma so as to cause, by reaction and/or ionization, reactants to appear, which reactants react with the surfaces to be treated.

The problem is that the electrodes are subject to very severe working conditions: the plasma is very hot; highly reactive products are injected and/or generated; and the voltage, current and frequency conditions can generate electrostatic forces and arcing at the surface of the electrode, possibly leading to localized breakdown and even pure and simple destruction of the electrode.

These problems are even more acute when the electrodes are placed in production lines for treating large-area surfaces, such as volumes of glass.

One method known to alleviate these problems consists in placing an electrically insulating layer on the side of the electrode facing the surface to be treated.

However, manufacturing such a composite electrode itself causes a series of technical problems that are not easy to solve. In the case of cylindrical electrodes, the dielectric may take the form of a sleeve, which solves, geometrically, the problem of fastening it to the surface of the electrode. However, the active surface follows one of the generatrixes of the cylinder, and it is therefore very small, thereby implying a relatively slow run speed and/or the use of a plurality of electrode elements.

Planar electrodes also cause problems, especially if they are large: the intrinsic geometry of planar surfaces cannot be used as a fastening means. Moreover, the dielectric and the planar electrode material (generally a metal) have expansion coefficients that are often very different, thereby making them difficult to manufacture and use.

Various techniques may be used to securely fasten the electrode and the dielectric layer.

WO 2004/001790 and US 2005/0226802 use adhesive bonding. The nature of the adhesive is not taught. In the first document one of the electrodes is porous. In the second, the context in which the electrodes are used is the production of chemical substances. In WO 2007/038256, which relates to the elimination of bad smells, a metal grid is adhesively bonded to a dielectric using a silicone adhesive. In US 2006/0196424, intimate contact between the metal and dielectric parts of the electrodes is obtained via insertion of an electrically conductive liquid, or an electrically conductive adhesive polymer.

In US 2007/0182327, anodization is used to produce the joint. US 2005/0179395 employs sputtering. WO 00/718866 employs electrodeposition. Chemical vapor deposition is mentioned in U.S. Pat. No. 6,692,704. U.S. Pat. No. 6,692,704 uses dip coating.

US 2008/179286 A1 discloses a geometrical description of the manufacture of a DBD electrode, but does not mention the way in which the latter is assembled.

WO 02/35576 A1 relates to a device for cooling a DBD electrode, but mentions nothing about a polymer interlayer.

The first object of the invention is to provide a large planar electrode for DBD processes.

Another aim of the invention is for this electrode to be durable.

Another aim of the invention is for this electrode to prevent localized arcing.

Another aim of the invention is for this electrode to be relatively easy and reasonably inexpensive to produce.

The first subject of the invention is a planar electrode for DBD plasma treatment of surfaces, said electrode being intended to be raised to a high voltage and comprising a metal envelope, said envelope comprising an active part able to be placed parallel to a surface to be treated, said active part being covered on the outside by a dielectric sheet, said electrode being characterized in that the dielectric sheet is fixed to the active part by a polymer interlayer.

Advantageously, an internal side of the active part forms a heat exchanger with the metal envelope, which heat exchange may be designed to be connected to a cooling circuit in which a heat-transfer fluid or a refrigerant, also called a coolant, flows.

Another subject of the invention is a device comprising a planar electrode for DBD plasma treatment of surfaces, which electrode is connected to at least one cooling circuit and is intended to be raised to a high voltage, said electrode comprising a metal envelope, the envelope comprising an active part able to be placed parallel to a surface to be treated, said active part being covered on the outside by a dielectric sheet, characterized in that the dielectric sheet is fixed to the active part by a polymer interlayer, an internal side of the active part forming a heat exchanger with the metal envelope, the heat exchanger being connected to at least one cooling circuit in which a heat-transfer fluid flows.

Advantageously, the polymer interlayer has an elongation at break compatible with a linear thermal expansion coefficient differential of, for a temperature range of 0 to 100° C., between 0.01×10⁻⁶/° C. and 1000×10⁻⁶/° C. This enables good adhesion between the dielectric sheet and the active part of the electrode and prevents any mechanical degradation, such as tearing or shearing, of one relative to the other when heated.

According to one advantageous embodiment, the polymer interlayer is made of a polymer chosen from the following group: polymers produced by an in situ chemical reaction, thermosets, thermoplastics, EVA (ethylene vinyl acetate), and PVB (polyvinyl butyral). Advantageously this layer is between 0.3 and 0.7 mm in thickness, because this layer must be thick enough to take account of any variation in the dimensions of the dielectric sheet and active part.

According to one preferred embodiment, the interlayer is made of PVB (polyvinyl butyral).

According to another preferred embodiment, the refrigerant fluid is water.

This water preferably has a low mineral content, in order for it to have a low conductivity.

The electrode is very advantageously made of a material that has both a good electrical conductivity and a good thermal conductivity. Typically, the metal envelope is made of a metal having both an electrical conductivity of between 1 and 80 m/(Ωmm²) and a thermal conductivity of between 50 and 400 W/(mK).

The metal is advantageously copper.

The dielectric layer is for example a sheet of alumina, quartz or glass-ceramic, or another suitable material that may be used to identical effect.

Preferably, in the device, the electrode is connected to two cooling circuits, a primary cooling circuit and a secondary cooling circuit, respectively equipped with a first heat exchanger and a second heat exchanger. The second heat exchanger connecting the primary cooling circuit to the secondary cooling circuit via ducts made of a material with a low electrical conductivity, the length and the cross section of these ducts being calculated to be such that the insulation resistance of these ducts is high enough that grounding the second heat exchanger causes only a negligible leakage current. One advantage of this embodiment is that work may be carried out on the cooling circuit without danger to personnel safety.

According to another advantageous embodiment, the supply and return ducts of the secondary cooling circuit are wound around a drum. One advantage of this embodiment is that, whatever the length of the duct, the cooling system has a small footprint. Preferably, the supply and return ducts of the secondary cooling circuit are placed side-by-side on the drum.

The secondary cooling circuit may furthermore comprise a control system that periodically measures the conductivity of the coolant.

Preferred and advantageous embodiments of such a device are those described above for the electrode.

Another aspect of the invention is a method for manufacturing a planar electrode for DBD plasma treatment of surfaces, such as defined above, comprising the following operations:
a) manufacturing a metal envelope able to be raised to a high voltage, this envelope comprising an external planar part and an internal volume in which a coolant can flow;
b) placing a polymer film on the external side of the planar part;
c) positioning a dielectric sheet on this polymer layer;
d) heating the electrode until the polymer film softens;
e) placing the electrode assembly thus formed in a vacuum until any bubbles have disappeared;
f) placing the electrode assembly thus formed under pressure; and
g) gradually cooling the electrode.

In step a), this envelope may be manufactured in a number of parts, which are joined together using one of the various methods known to those skilled in the art.

In step b), the external side (or part) of this planar envelope is hot coated with a polymer layer. The polymer may also be injected between two prepositioned surfaces.

Placing the electrode thus formed in a vacuum chamber and then in a pressure chamber, in steps e) and f), has the advantage of preventing air bubbles from forming, these bubbles being liable to cause localized electric arcing.

According to an advantageous embodiment, the polymer layer is made of polyvinyl butyral (PVB).

One advantage of the invention is that PVB, although it cannot withstand very high temperatures, does allow a very substantial differential expansion, due to the difference between the thermal expansion coefficients of the active part and the dielectric, to be absorbed.

These and other aspects of the invention are illustrated in the detailed description of particular embodiments thereof, reference being made to the drawings, in which:

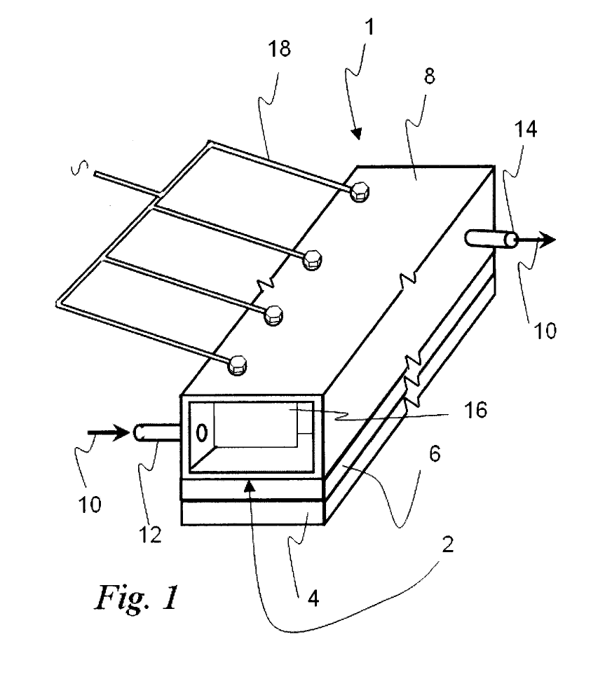

FIG. 1 is a partial cross-sectional semi-isometric perspective view of the electrode according to the invention;

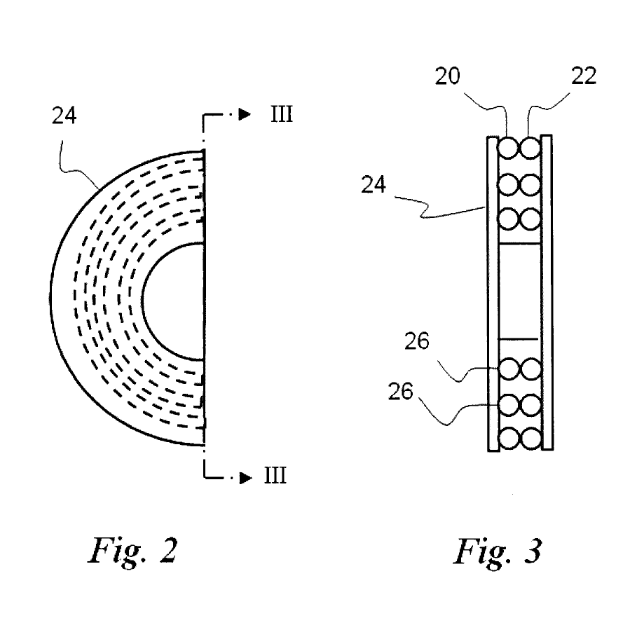

FIG. 2 is a cross-sectional perspective view of the supply coil of the electrode in FIG. 1;

FIG. 3 is a schematic cross-sectional view of the coil in FIG. 2, in the plane III-III; and

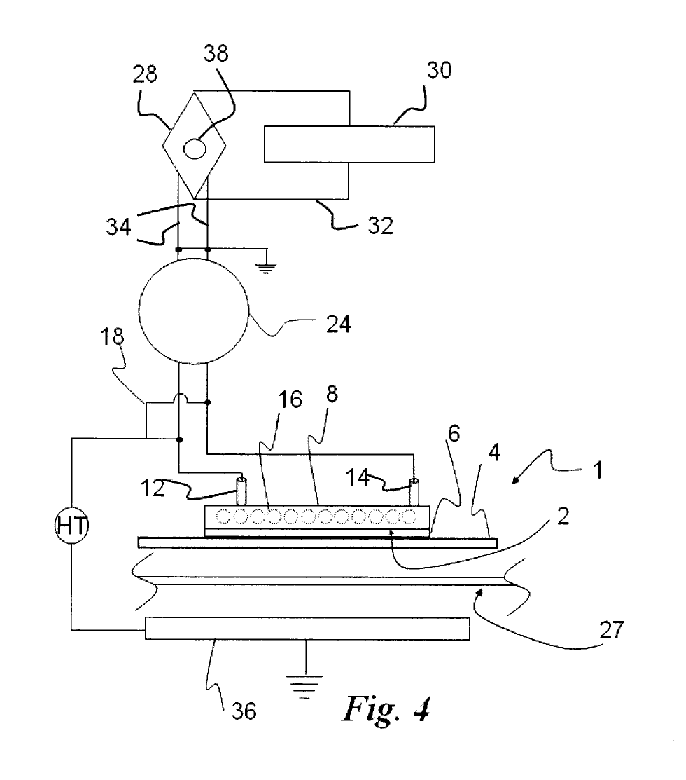

FIG. 4 is a schematic view of the electrode assembly in its entirety, comprising two cooling circuits.

The figures are not to scale (the thicknesses have in particular been enlarged for the sake of legibility). Generally, similar elements have been given identical references in the figures.

FIG. 1 is a schematic illustration of the electrode of the invention. Since this electrode 1 was above all developed to treat and/or coat the surfaces of large volumes of glass, it may typically be about four meters in length, which is why only a partial view is shown.

This electrode 1 is normally fitted facing another electrode, a plasma being generated in the gap separating these two elements by applying a very high-voltage HF electric field between the electrodes. The “active” part of the electrode, i.e. the part oriented toward this second electrode 36 is an essentially flat area 2, shown here oriented downward (FIG. 4). One of the problems that those skilled in the art are confronted with is the risk of sparks forming in the ionized gases. Such sparks draw a very high current, not only wasting energy but also causing defects in the surfaces to be treated and degrading the electrodes. A dielectric layer 4, for example a sheet of alumina, quartz, glass-ceramic or another suitable material, is placed in the gap between the electrodes in order to prevent this phenomenon.

Interposing such a dielectric layer 4 solves the problem of breakdown but causes other problems, such as how to bind the dielectric layer 4 to the active part 2 of the electrode 1. Since these are made of materials of not easily compatible natures, extremely sophisticated adhesive bonding techniques are generally used, which generally employ intermediate interlayers made of various materials, thereby increasing the manufacturing cost of an electrode. Moreover, the electrode is very advantageously made of an excellent electrical conductor, especially so as to reduce Joule losses, thereby implying the use of metals such as copper, silver, etc. However, these metals generally have a high expansion coefficient, quite unlike dielectrics. The binding layer is therefore subjected to high shear forces.

It has therefore been envisioned, instead of using conventional techniques (welding, compatible molecular coatings, pure and simple adhesive bonding), to form this joint using an interlayer 6. However, it is not obvious which materials would form suitable interlayers.

Specifically, this interlayer 6 must form a uniform joint, for example preventing micro air bubbles that are liable to flaw the dielectric insulation from appearing, and must ensure that the sides of the materials to be joined remain absolutely parallel.

The interlayer 6 must have adhesive properties allowing the two materials to be held together under uncommon stress conditions (temperature and pressure).

The interlayer 6 must have a high elongation at break in order to withstand the mechanical stress caused by the thermal expansion differential of the materials to be joined. The elongation will therefore be compatible with the linear thermal expansion coefficient differential of the materials to be joined, which in general, for a temperature range of 0 to 100° C., is between 0.01×10⁻⁶/° C. and 1000×10⁻⁶/° C., preferably between 0.1×10⁻⁶/° C. and 100×10⁻⁶/° C., and more preferably between 5×10⁻⁶/° C. and 50×10⁻⁶/° C.

Said interlayer 6 must furthermore be very substantially chemically inert over a wide temperature range, the maximum temperature at which it may be used continuously possibly being as high as 80° C.

According to a preferred embodiment, the interlayer is a polymer layer 6 having “elastic” properties (for example an elastomer) or “viscoelastic” properties, able to withstand very substantial strains before splitting.

The interlayer 6 selected is not necessarily a commercially available, ready-to-use material, it may be synthesized chemically in situ in order to meet the aforementioned requirements.

More particularly, of the range of polymers meeting these mechanical criteria, it may be envisioned to use an unconventional binding material, namely a layer of polyvinyl butyral 6, a polymer conventionally used, essentially because it is transparent, to manufacture windshields or bullet proof glass. Using polyvinyl butyral in this way is somewhat illogical since here its optical properties are of absolutely no importance, and in addition it is not being used to bind glass sheets (where the question of differential thermal expansion coefficients is obviously not an issue), but to bind a metal and a dielectric. Surprisingly, test results are conclusive, except that polyvinyl butyral is totally incompatible with the temperature range encountered in a plasma reactor. It will be noted that a plasma can easily reach a temperature of at least 200° C., and typically reaches a temperature of between 200° C. and 600° C. It has therefore been necessary to develop specific technology to limit the temperature increase in the binding layer 6.

The electrode body, of which the planar surface 2 is part, is hollow and forms a closed envelope 8 in which a coolant 10 flows, thus forming the first heat exchanger 2, 8. This coolant enters into the electrode via an inlet duct 12 and exits therefrom via an outlet duct 14. The envelope 8 is equipped with means promoting heat exchange with the coolant 10, such as baffles 16. However, the flow of the coolant 10 should not be obstructed as a high flow rate is required in order to dissipate about 30 W/cm² from across the entire area of the electrode 1.

The thickness of the polyvinyl butyral layer 6 (enlarged in the figure) is calculated to be such that it is easily able to withstand the strain due to the expansion coefficient differential between the two joined surfaces. Moreover, the interlayer must not be too thick otherwise the transfer of heat to the cooling circuit and the transfer of electrical energy to the plasma will be slowed. A good compromise is obtained with a thickness of about 0.7 mm.

Specific technology had to be developed to ensure the absence of gas bubbles in the binding layer 6. Specifically, there is a risk that bubbles, if they were present, would lead to breakdown within this very same binding layer. The assembly is therefore carried out in the following way: after the polyvinyl butyral sheet has been placed on the external side of the planar part of the electrode and said planar part has been covered with a dielectric sheet, the electrode is placed in a sealed chamber and heated until the polyvinyl butyral sheet softens. The chamber is then pumped down in order to promote degassing of the PVB film. Miniscule trapped gas bubbles thus migrate through the viscous polymer toward the exterior, where they are removed, until they have completely disappeared. The chamber is then pressurized in order to apply an initial stress and bring the assembled components into intimate contact, which components are finally cooled.

As mentioned above, there is every reason to dissipate the heat transmitted to the electrode by the plasma as quickly as possible. Therefore, there is every reason for the electrode to be made of a single piece. However, an embodiment in which its active side 2 is joined to the hermetic envelope 8 acting as a heat exchanger (2, 8) is not ruled out.

When the electrode 1 has been assembled it still needs to be incorporated into a plasma generating tool, in which it will be raised to a very high voltage. In order to prevent a nonuniform voltage distribution, the electrode is supplied via a “multipoint” connection 18, which places the various zones of the electrode in parallel. Furthermore, as cooling is essential because PVB is being used, a heat-transfer fluid must be made to flow under a very high voltage, typically 40,000 volts. This conventionally involves integrating a heat exchanger that is isolated from ground, into the tool, thereby making the exchange circuits more complex and bulky and increasing the risk of an accident. It has therefore been sought to develop a simpler and potentially less dangerous system. Rather than completely isolating the electrode, a high resistance is placed between the electrode and ground, so that the leakage current resulting therefrom is negligible. It is therefore possible to use an illogical heat-transfer fluid that however has a series of physical advantages: pure water. Specifically, water with a low mineral content is a remarkably poor conductor. This water is piped to the electrode and exits from the latter via two long ducts 20 and 22 made of intrinsically insulating polymers.

The required resistance is calculated using the formula R=ρ·l/s, where:

ρ=10⁹ Ωm (resistivity of distilled water);

l(m)=the length of each duct; and

s(m²)=the cross section of each duct.

An appropriate resistance, limiting leakage currents to tolerable values, is thus obtained by ensuring the ducts 20 and 22 are sufficiently long and have a sufficient cross section.

The problem of the footprint of these ducts is solved by winding them round a drum 24, such as shown schematically in FIGS. 2 and 3.

To prevent short-circuiting between the two ducts 20 and 22, between their own turns or their respective turns, the two ducts 20 and 22 are of identical length and are wound side-by-side in order to obtain a ΔV between them of nearly zero. Moreover, the ΔV between two consecutive turns 26 is greatly reduced. Thus, when the end of the two ducts is reached, they can be connected to the ground plane formed by a conventional heat exchanger without danger, their potential difference relative to the latter being at this point close to zero.

FIG. 4 shows a schematic of the electrode fitted to a DBD tool.

The electrode 1 is placed facing a substrate 27 to be treated. The inlet 12 and outlet 14 ducts of the secondary cooling circuit 34, on exiting the winding drum 24, are grounded (causing a negligible leakage current) and connected to the second heat exchanger 28. The primary cooling circuit 32 and this exchanger 28 are connected to a chiller group 30, the secondary cooling circuit 34 of this exchanger 28 being connected to the electrode 1 via the drum 24.

The electrode 1 itself is connected to one of the terminals of a high-voltage (and high-frequency) circuit, the other terminal being connected to a grounded counter electrode 36.

It will be obvious to those skilled in the art that the present invention is not limited to the examples illustrated and described above. The invention comprises each novel feature and their combination. The reference numbers should be considered nonlimiting. The term “comprises” is understood to in no way exclude the presence of additional elements other than those mentioned. The use of the definite article “a” to introduce an element does not rule out the presence of a plurality of these elements. The present invention was described with regard to specific embodiments, which are purely illustrative and must not be considered as limiting.

1. A planar electrode, comprising:
a metal envelope comprising an active part suitable for placing parallel to a surface to be treated,
a dielectric sheet on an outside of the active part, and
a polymer interlayer fixing the dielectric sheet to the active part,
wherein the electrode is suitable for DBD plasma treatment of a surface, and
the electrode is suitable for raising to a high voltage.

2. The electrode of claim 1, wherein an internal side of the active part forms a heat exchanger with the metal envelope.

3. The electrode of claim 2, wherein the heat exchanger is configured to connect to a cooling circuit in which a heat-transfer fluid flows.

4. The electrode of claim 1, wherein the polymer interlayer has an elongation at break compatible with a linear thermal expansion coefficient differential of, for a temperature of from 0 to 100° C., between 0.01×10⁻⁶/° C. and 1000×10⁻⁶/° C.

5. The electrode of claim 1, wherein the polymer interlayer comprises a polymer obtained by a process comprising chemically reacting in situ, a thermoset, a thermoplastic, EVA (ethylene vinyl acetate), PVB (polyvinyl butyral), or any combination thereof.

6. The electrode of claim 5, wherein the polymer interlayer comprises PVB (polyvinyl butyral).

7. The electrode of claim 3, wherein the heat-transfer fluid is water.

8. The electrode of claim 1, wherein the metal envelope comprises a metal having both an electrical conductivity of between 1 and 80 m/(Ωmm²) and a thermal conductivity of between 50 and 400 W/(mK).

9. The electrode of claim 8, wherein the metal is copper.

10. A device, comprising:
a planar electrode suitable for DBD plasma treatment of a surface and suitable for raising to a high voltage,
a cooling circuit connected to the electrode and configured to have a heat-transfer liquid flow through it,
wherein the electrode comprises a metal envelope comprising an active part suitable for placing parallel to a surface to be treated,
the electrode further comprises a dielectric sheet covering the active part, and a polymer interlayer fixing the dielectric sheet to the active part,
an internal side of the active part forms a heat exchanger with the metal envelope, and
the heat exchanger is connected to the cooling circuit.

11. The device of claim 10,
wherein the electrode is connected to two cooling circuits, a primary cooling circuit and a secondary cooling circuit, respectively equipped with a first heat exchanger and a second heat exchanger,
the second heat exchanger connects the primary cooling circuit to the secondary cooling circuit via a supply duct and a return duct, each comprising a material with a low electrical conductivity,
a length and a cross section of the supply duct and a length and a cross section of the return duct are such that an insulation resistance of each of these ducts is high enough that grounding the second heat exchanger would cause only a negligible leakage current.

12. The device of claim 11, wherein the supply duct and the return duct are wound around a drum.

13. The device of claim 12, wherein the supply duct and the return duct are side-by-side on the drum.

14. The device of claim 10, wherein the secondary cooling circuit comprises a control system configured to periodically measure a conductivity of the heat-transfer fluid.

15. The electrode of claim 4, wherein the elongation at break is compatible with a linear thermal expansion coefficient differential of, for a temperature of from 0 to 100° C., between 5×10⁻⁶/° C. and 50×10⁻⁶/° C.

16. The electrode of claim 1, wherein a thickness of the polymer interlayer is between 0.3 and 0.7 mm.

17. The electrode of claim 7, wherein the heat-transfer fluid is pure water.
